(19) United States
(12) Patent Application Publication
(10) Pub. No.: US 2009/0132765 A1
(43) Pub. Date: May 21, 2009

(54) DUAL CONTROLLER STORAGE APPARATUS AND CACHE MEMORY MIRROR METHOD THEREOF

(75) Inventors: Jian-Zhong Wang, Tianjin (CN); Tom Chen, Taipei (TW); Win-Harn Liu, Taipei (TW)

Correspondence Address: STEVENS & SHOWALTER LLP, 7019 CORPORATE WAY, DAYTON, OH, 45459-4238, US

(73) Assignee: Inventec Corporation, Taipei (TW)

(21) Appl. No.: 11/943,652

(22) Filed: Nov. 21, 2007

(51) Int. Cl. G06F 12/00

(52) U.S. Cl. 711/120; 711/E12.001

(57) ABSTRACT

A dual controller storage apparatus and a cache memory mirror method thereof are described. The storage apparatus includes a imaging environment module, a storage device, a first controller, and a second controller. The first controller has a virtual disk and a first cache memory. The second controller has a second cache memory. The present invent provides a imaging environment function to select the first or the second controller to serve an extranet according to the request of the extranet. If the imaging environment function selects the second controller, the data received from the extranet is written into the second cache memory. Communication between the second controller and the first controller is established, and the data of the second controller received from the extranet into the first cache memory and the virtual disk.

### BACKGROUND OF THE INVENTION

1. Field of Invention

The present invention relates to a dual controller storage apparatus and a cache memory mirror method thereof. More particularly, the present invention relates to a dual controller storage apparatus and a data mirroring method of a cache memory in the dual controller storage apparatus.

2. Related Art

In order to improve the access performance of a storage device, a dual controller storage apparatus is provided. Compared with a single controller, a dual controller can provide the same service to multiple clients at the same time.

The conventional dual controller storage apparatus adopts a imaging environment function (same view) to ensure that multiple clients have the same operating environment. The imaging environment function is mainly used to ensure that the clients when being connected to a storage device may not have different operating environments and services under the condition that different controllers are used to provide services. For example, when a virtual disk is created in a first controller, the other clients may also find the virtual disk if being connected to the storage apparatus through a second controller.

In order to ensure the data synchronization when the dual controller accesses data, besides the imaging environment function, a “mirror cache” function is proposed. The mirror cache means that each controller has an individual cache memory. When receiving or retrieving data, a first controller will replicate the data temporarily stored in the cache memory thereof into the cache memory of a second controller, thereby ensuring the data in both controllers is the same. Moreover, when one of the two controllers fails, the storage apparatus may retrieve the lost data from the cache memory of the other controller.

Referring to FIG. 1, a combined schematic view of the flow of a imaging environment function and a mirror cache function is shown. Data is written into a storage apparatus (Step S110). A controller is selected for providing services (Step S120). It is determined whether or not the selected controller has a virtual disk (Step S130). If the selected controller has a virtual disk, data is written into the cache memory of the selected controller (Step S141). Data is written into the cache memory of the other controller (Step S142). The selected controller writes the data into the virtual disk (Step S143).

If the selected controller does not have a virtual disk, the selected controller sends the data to the other controller through interlinking (Step S151). Data is written into the cache memory of the other controller (Step S152). The cache memory of the other controller sends the data to the cache memory of the selected controller, and writes the data into the cache memory of the linked controller (Step S153). The other controller writes the data into the virtual disk (Step S154).

According to the above imaging environment and mirror cache functions, although a fine operating environment/data synchronization of the dual controller storage apparatus may be achieved, the access load of the storage apparatus is increased during the data transmission between the cache memories of the first and second controllers in operation.

### SUMMARY OF THE INVENTION

Accordingly, the present invention is mainly directed to improve the mirror cache efficiency of a dual controller storage apparatus. The storage apparatus provides a imaging environment service, such that when different clients connected to different controllers in the storage apparatus have the same operating environment.

In order to achieve the above objective, the dual controller storage apparatus of the present invention includes a imaging environment module, a storage device, a first controller, and a second controller. The first controller is used to provide relevant service to a client, and a first cache memory is used to temporarily store the data received by the first controller. The second controller is used to provide relevant service to a client, and a second cache memory is used to temporarily store the data received by the second controller. The imaging environment module is electrically connected to an extranet, the first controller, and the second controller respectively, for assigning the controllers, such that each of the controllers receives the data transmitted from the extranet. Moreover, the imaging environment module determines the sequence of synchronous updating of the first cache memory and the second cache memory. The storage device is electrically connected to the first controller and the second controller, for recording the data received from the extranet.

From another point of view, the present invention provides a cache memory mirror method of the dual controller storage apparatus.

In order to achieve the above objective, the cache memory mirror method of the dual controller storage apparatus of the present invention includes the following steps. A controller selecting means is provided, for selecting the first or the second controller to be connected to an extranet. A determination mechanism is utilized, for determining whether the controller selected by the controller selecting means is connected to a virtual disk. A imaging environment means is provided, for allowing the second controller to access the virtual disk through the first controller, and write the accessed data into the first cache memory and the second cache memory respectively.

A dual controller storage apparatus and a cache memory mirror method thereof are provided. Thus, when accessing data of the first controller and the second controller, the data in the two cache memories may be kept synchronous. Besides, the times of accessing between the cache memories are reduced, and the access performance of the storage apparatus is improved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a combined schematic view of the flow of a imaging environment function and a mirror cache function;

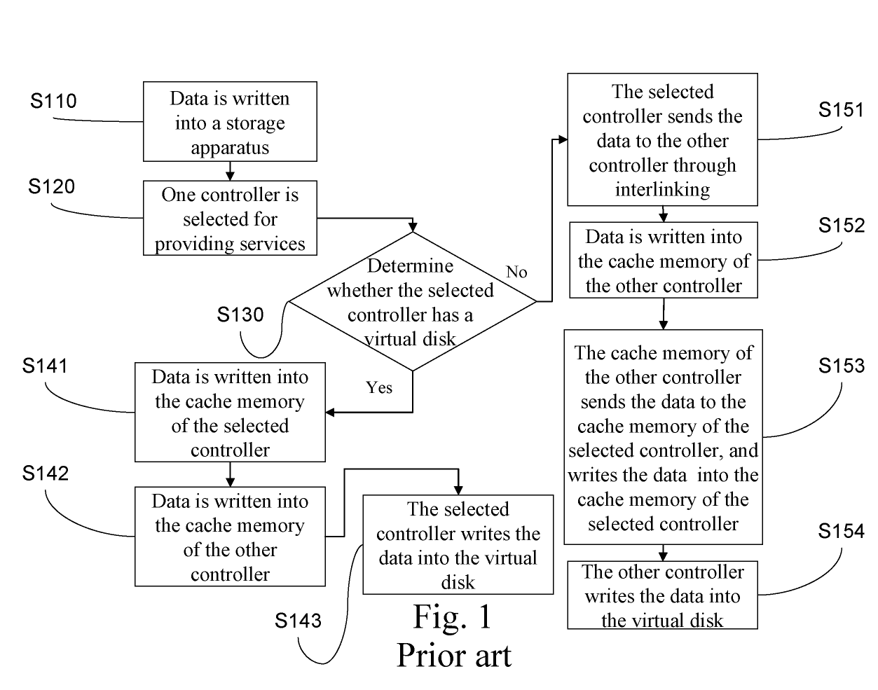

FIG. 2 is a schematic architectural view of a storage apparatus according to the present invention;

FIG. 3 is a flow chart of a detailed operation of the present invention;

FIG. 4 is a schematic view of an operation between the elements of the present invention; and

FIG. 5 is a schematic view of the operation between the elements of the present invention.

### DETAILED DESCRIPTION OF THE INVENTION

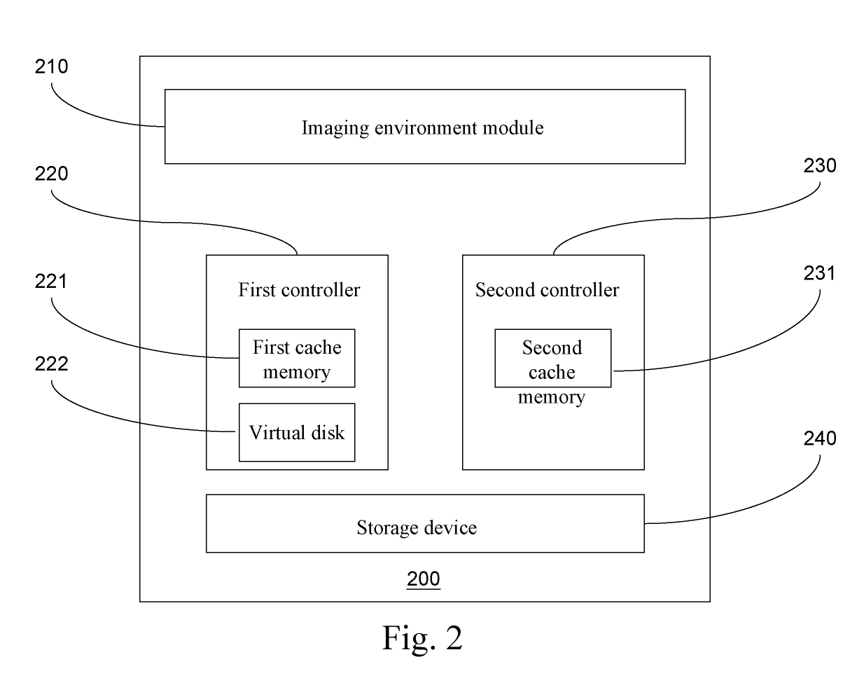

The present invention provides a dual controller storage apparatus. Referring to FIG. 2, a schematic view of an architecture of a storage apparatus according to the present invention is shown.

The dual controller storage apparatus is constituted by embedded systems, or multiple computers. In this embodiment, embedded systems are taken for illustration. The dual controller storage apparatus 200 includes a imaging environment module 210, a first controller 220, a second controller 230, and a storage device 240.

The imaging environment module 210 is electrically connected to an extranet, the first controller 220, and the second controller 230 respectively. The imaging environment module 210 is used to assign the controllers, such that each controller receives the data transmitted from a client or provides relevant service to the client. Besides, the imaging environment module 210 determines the sequence of synchronous updating of the first cache memory 221 and the second cache memory 231.

The storage device is electrically connected to the first controller 220 and the second controller 230, for recording data received from the extranet. The first controller 220 further includes a first cache memory 221 and a virtual disk 222. The first controller 220 is used to provide relevant service to a client. The virtual disk 222 is used to store the data of the first controller 220, and the first cache memory 221 is used to temporarily store the data of the first controller 220.

The second controller 230 further includes a second cache memory 231, for temporarily storing the data received by the second controller 230. It should be noted that data exchange between the first controller 220 and the second controller 230 is conducted through interlinking. For example, when the second controller 230 intends to access the virtual disk 222, the second controller 230 sends an interlink information to the first controller 220, and accesses the virtual disk 222 through the first controller 220.

The present invention provides a cache memory mirror method of the dual controller storage apparatus 200. The mirror method includes the following steps. A imaging environment means is provided to select the first controller 220 or the second controller 230 to serve an extranet according to the request of the extranet. If the imaging environment means selects the second controller 230, the data received from the extranet is written into the cache memory of the second controller 230. Communication between the second controller 230 and the first controller 220 is established, and the data of the second controller 230 received from the extranet is written into the cache memory and the virtual disk 222 of the first controller 220.

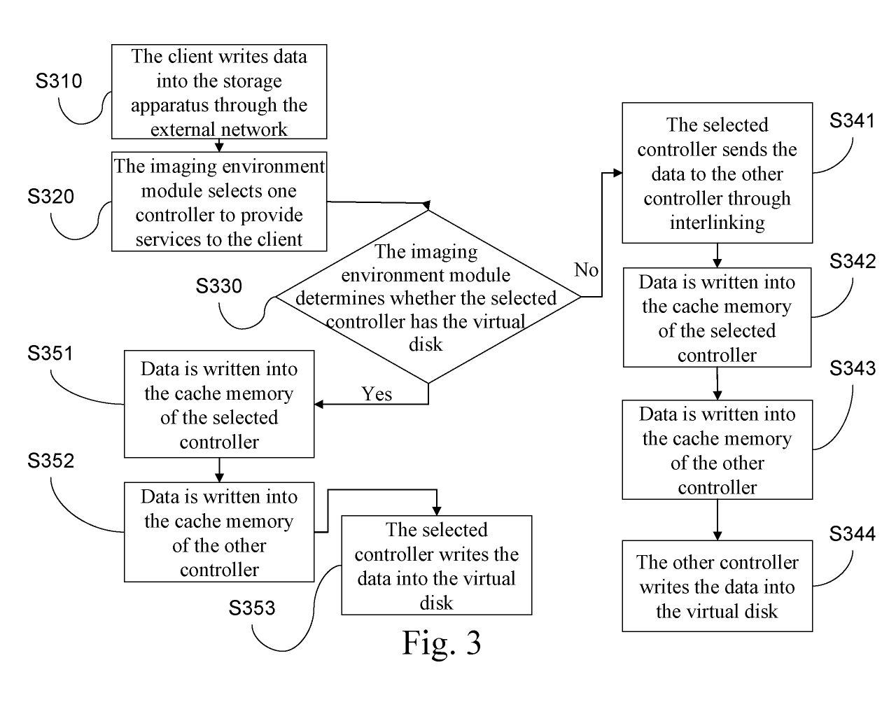

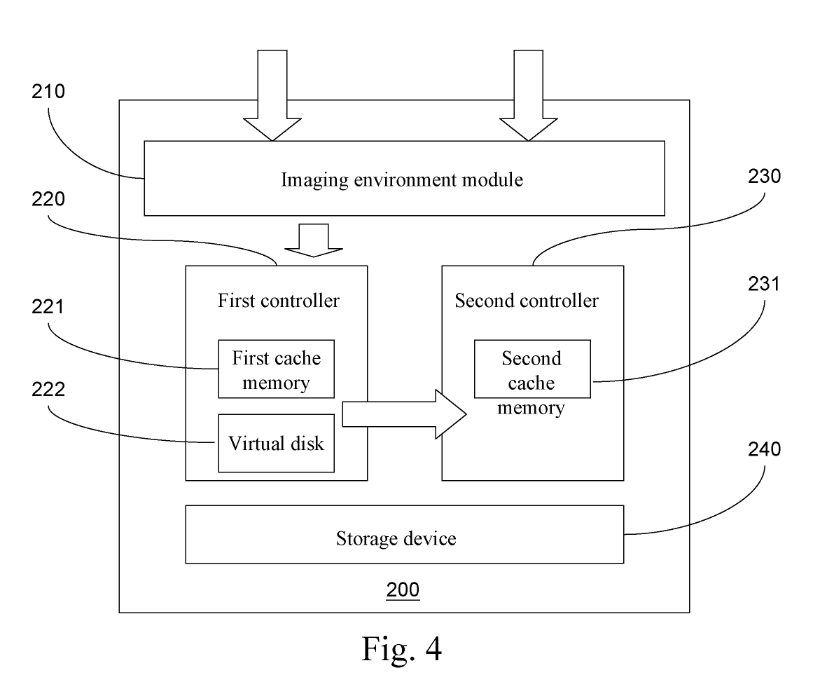

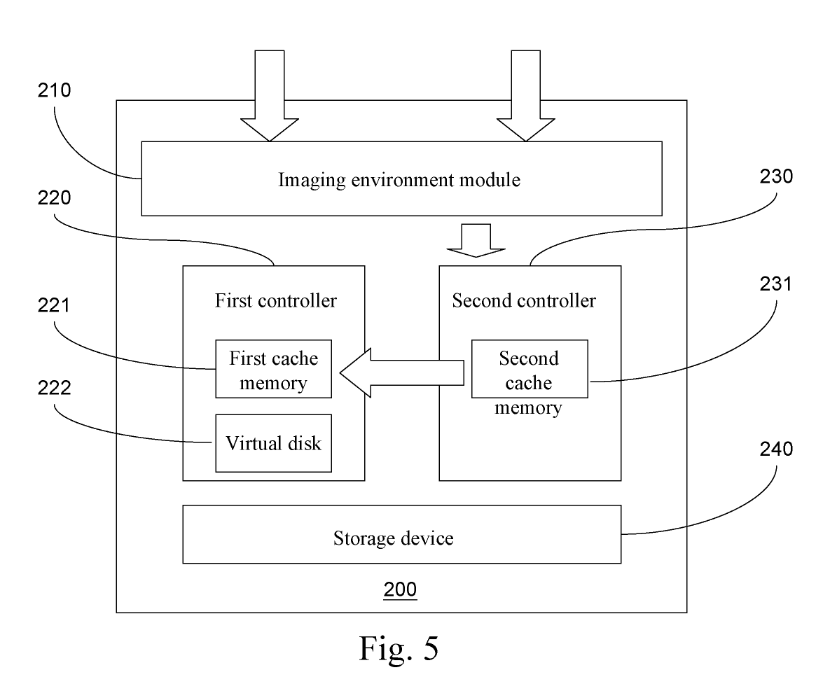

The above elements will be described in detail below to clearly explain the operation between the elements. Referring to FIG. 3, a flow chart of a detailed operation of the present invention is shown. Referring to FIGS. 4 and 5, schematic views of a process and an operation between the elements of the present invention are shown. The client writes data into the storage apparatus through the extranet (Step S310). The imaging environment module selects one controller to provide services to the client (Step S320). The imaging environment module determines whether the selected controller has the virtual disk (Step S330).

If the linked controller does not have the virtual disk, the selected controller sends the data to the other controller through interlinking (Step S341). If the linked controller does not have the virtual disk 222, the linked controller is the second controller 230. Data is written into the cache memory of the selected controller (Step S342). Data is written into the cache memory of the other controller (Step S343). The other controller writes the data into the virtual disk 222 (Step S344). The data flow from Step S341 to Step S343 is shown in FIG. 4, and all the steps are corresponding to the direction indicated by arrow marks between the elements in FIG. 4.

If the selected controller has the virtual disk, data is written into the cache memory of the selected controller (Step S351). The linked controller having the virtual disk 222 is the first controller 220. Data is written into the cache memory of the other controller (Step S352). The selected controller further writes the data into the virtual disk 222 (Step S353). The data flow from Step S351 to Step S353 is shown in FIG. 5, and all the steps are corresponding to the direction indicated by arrow marks between the elements in FIG. 5.

Different from the prior art, in this embodiment, data is written into the first cache memory 221 and the second cache memory 231 respectively at the same time. Therefore, the step that the first cache memory 221 sends the data back to the second cache memory 231 is not required to be repeated.

The present invention provides a dual controller storage apparatus 200 and a cache memory mirror method thereof. When data of the first controller 220 and the second controller 230 is accessed, the data in the first cache memory 221 and the second cache memory 231 can be kept synchronous. Moreover, the times of accessing between the cache memories are reduced, and the access performance of the storage apparatus 200 is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dual controller storage apparatus, for providing a imaging environment service, the storage apparatus comprising:
a storage device, for storing data;
a first controller, electrically connected to the storage device, wherein the first controller further comprises a first cache memory for temporarily storing data received by the first controller;
a second controller, providing relevant service to a client, wherein the second controller further comprises a second cache memory, for temporarily storing data received by the second controller, and communication between the second controller and the first controller is established through interlinking; and
a imaging environment module, electrically connected to an extranet, the first controller, and the second controller respectively, for assigning the controllers, such that each of the controller receives the data transmitted from the extranet, wherein if the imaging environment module designates the second controller to provide service, the data received by the second controller is directly written into the second cache memory, and the data in the first cache memory is updated through interlinking.

2. The dual controller storage apparatus as claimed in claim 1, wherein the first controller has a virtual disk connected thereto, and the virtual disk provides to store data for the first controller.

3. The dual controller storage apparatus as claimed in claim 2, wherein the imaging environment module determines whether the controller selected by the imaging environment means has the virtual disk connected thereto; if not, the data received from the extranet is written into the cache memory of the controller, and the data received from the extranet is written into the cache memory and the virtual disk of the other controller.

4. A cache memory mirror method of the dual controller storage apparatus, wherein the dual controller has a first controller and a second controller communicating with each other, the first controller has a virtual disk and a first cache memory, and the second controller has a second cache memory, the mirror method comprising:
providing a imaging environment means to select the first or the second controller to serve an extranet according to a request of the extranet;
if the imaging environment means selects the second controller, writing data received from the extranet into the second cache memory; and
establishing communication between the second controller and the first controller, and writing the data of the second controller received from the extranet into the first cache memory and the virtual disk of the first controller.

5. The cache memory mirror method of the dual controller storage apparatus as claimed in claim 4, further comprising:
if the controller connected to the network has the virtual disk, writing the data received from the extranet into the cache memory and the virtual disk of the controller; and
sending the data received from the extranet to the other controller, and writing the data into the cache memory of the other controller.

6. The cache memory mirror method of the dual controller storage apparatus as claimed in claim 4, further comprising:
the controller writing the data received from the extranet into a storage device of the storage apparatus.
